(19) United States
(12) Patent Application Publication
(10) Pub. No.: US 2009/0089924 A1
(43) Pub. Date: Apr. 9, 2009

(54) Spa tub apparatus

(76) Inventor: Jonathan Jan, Culver City, CA (US)

Correspondence Address: LAW OFFICES OF CLEMENT CHENG, 17220 NEWHOPE STREET #127, FOUNTAIN VALLEY, CA, 92708, US

(21) Appl. No.: 11/973,264

(22) Filed: Oct. 6, 2007

(51) Int. Cl. A61H 33/00; A47K 3/10; A61H 33/06

(52) U.S. Cl. 4/541.5; 4/541.1; 4/545

(57) ABSTRACT

The present invention has four components, a power unit, a flexible air hose, a hydro-jet board, and a remote control. The power unit is a chamber having pressurized air. The power unit further includes an air compressor to create a pressurized air. Air compression typically increases the temperature of the air flow, however it is also desired to further heat the pressurized air before introducing the air into the flexible air hose. The flexible air hose is connected to a water jet board. The flexible air hose has a first and second connector, one at each end. The water jet board is comprised of a bottom plate laminated to a top plate. The hydro-jet board is constructed by laminating two pre-formed plastic sheets to create the specific air channels thereby supplying pulsating water jets at specific zones.

### DISCUSSION OF RELATED ART

Many people use spas for relaxation, massage, soaking and hydrotherapy. The hot water temperature is comforting and even therapeutic for some while others avoid it for that very reason. Although the terms hot tub, spa, Jacuzzi and whirlpool bath may seem interchangeable they refer to very distinct devices.

Hot tubs contain heated water and often have jets for massage purposes. They are normally placed outdoors under a shelter and are often used at hot springs. Hot tubs may be constructed of wood or plastic and heat water via an electric or natural gas heater. Sanitization is an important issue especially for hot tub owners because many bacteria and other organisms thrive in the high temperature wet environment so pumps and filters are necessary to sanitize the water in addition to prevent damage to the hot tub itself.

Spas normally consist of a one-piece plastic tub made of acrylic and are commonly installed outdoors on a patio or deck. They can also be installed indoors with a little more work and planning. Spas have contoured seats that are chair or bench shaped and may also include a pressure system for jets that create whirlpool actions of horizontal water. Spas also require filtering systems to reduce bacteria build-up since water remains in the spa at all times. Whirlpool baths on the other hand, are installed in bathrooms and are much less expensive than the outdoor spas. Whirlpool baths are essentially bathtubs with jets attached. Water sanitization is not a concern because the baths are drained after each use.

Contrary to popular usage, Jacuzzi is not a type of spa but actually a brand name that took on a broader meaning. Jacuzzi first marketed their whirlpool spas in the United States as a therapeutic aid in the mid 1950's and now manufactures both spas and hot tubs. Marquis and Emerald are also well known spa manufacturers. Spas are easily customized and can be installed in a variety of settings according to the consumer's needs.

In general, “Home spas” are made of plastic shells and can be located above ground or in ground in addition to outdoor or indoor use. Most manufacturers recommend concrete bases for spas. Many spas feature digital controls for the temperature and jet settings. Spa sizes can vary greatly from several thousand pounds to much smaller portable spas that require no installation except a wall outlet. Consumers will need to take many issues into consideration when purchasing a spa such as power consumption, environment, maintenance, installation and size.

Therefore, a pool or spa provides relaxation for users. Traditionally, a variety of jets operated in a Venturi configuration sucks air from an air supply to provide a jet of bubbles and water for circulating water and air against user skin. One example of such a jet device is described in U.S. Pat. No. 6,164,337 issued on Dec. 26, 2000 to Weise. By capturing air from an air supply, the water jet entrains the air within the water flow thereby maintaining jet pressure.

Hydrotherapeutic devices have been popular since the 1960's when Jacuzzi™ introduced the first commercial integrated whirlpool spa. Such devices incorporate water pumps and water jets on the side of bathtub creating whirlpool actions of horizontal water flow in the bathtub. Such spas are heavy, usually weighing several hundred pounds, expensive, and require high maintenance. Keeping the internal plumbing components clean and sanitized is a health challenge.

Tub appliances have previously been built into the bathtub. This increases the costs as well as the difficulty of cleaning and maintaining multiple components. Furthermore, electrical shock is a risk because components may become exposed to bath water. Also, traditional spas are not portable. A variety of massage units have water jets mounted on the sides of the tub wall. In this unfortunate situation, users can only sit in the tub and receive whirlpool actions on their back. Therefore, deep muscle massage and releasing tensed ligaments is sometimes not available since the patient cannot lay down flat on top of the jets.

### SUMMARY OF THE INVENTION

The present invention has four components, a power unit, a flexible air hose, a hydro-jet board, and a remote control. The power unit is a chamber having pressurized air. The power unit further includes an air compressor to create a pressurized air. Air compression typically increases the temperature of the air flow, however it is also desired to further heat the pressurized air before introducing the air into the flexible air hose. The flexible air hose is connected to a water jet board. The flexible air hose has a first and second connector, one at each end. The water jet board is comprised of a bottom plate laminated to a top plate. The hydro-jet board is constructed by laminating two pre-formed plastic sheets to create the specific air channels thereby supplying pulsating water jets at specific zones.

The present invention differs from a traditional spa tub pparatus in many respects, the jet is powered by the air pump instead of a water pump. Also, compressed air is heated before it is introduced into the bathtub via the air hose. The hydro-jet board serves as a transducer converting the compressed air into pulsating water jets in the bathtub. The pulsating water jets vector vertically upward action offers anti-gravity benefits that helps relaxing muscles and joints lacking in traditional horizontal whirlpools. Also, while the user lies down flat against the hydro-jet board, which is affixed to the bottom of the bathtub, the entire back area is covered with numerous jets targeting at major acupressure points as well as joints. The user can also move the body around to treat other body components. Hands, knees, elbows, and feet, for example, can be treated accordingly.

The remote control allows the user to adjust the thrust and temperature of the hydro-jet without leaving the bathtub. The remote control feature is an added safety measure to prevent possible electrical shock. Also, the entire assembly preferably weighs less than 10 pounds so as to be easily packed in most travel luggage.

### BRIEF DESCRIPTION OF THE DRAWINGS

FIG. 1 is an exploded view of the present invention.

FIG. 2 is a cross section of the hydro-jet board.

FIG. 3 is an environmental side view of standard operation.

The following call a list of elements is designed to provide convenient reference.
12 flexible hose
15a, 15b hose connector
22 hose connection
26 air channel
25 bridge
29 ridge
57 suction cup
60 hydro-jet board
61 bottom plate
62 top plate
88 air hole
91 air outlet
96 compressed air chamber
98 receiver
92 remote control
93 air inlet
95 transmitter
888 bubble and water jet

### DETAILED DISCUSSION OF THE PREFERRED EMBODIMENT

The present invention has four components, a power unit 90, a flexible air hose 12, a plastic hydro-jet board 60, and a remote control 92. The power unit is preferably powered by household electric and having a plug for plugging into the wall so that the power unit has enough power to pressurized a chamber to create a pressurized air chamber 96. The power unit further includes an air compressor to create a pressurized air which takes air from an air inlet 93 and passes air to an air outlet 91. Air compression may complement an increase in the temperature of the air flow, however it is also desired to further heat the pressurized air before introducing the air into the flexible air hose. The air compression motor 11 is preferably the resistance heater that warms the air before the air gets to the board 60. Where the air compression motor is insufficient to keep the air at a highly heated temperature, resistance heating can add additional heat to the airflow so that a user can adjust the temperature to a hot enough temperature. A wide variety of air resistance heating methods are known in the art. The air pressurization motor is preferably located within the air chamber 96 so that it generates a resistance heated air flow. The air inlet 93 preferably has some kind of air filter so that dust particles do not enter. The air outlet 91 receives a hose connector coupling 15b.

The water jet board 60, FIG. 2 is comprised of a plastic bottom plate 61 laminated to a plastic top plate 29. The hydro-jet board 60 is constructed by laminating two pre-formed plastic sheets and also forming air holes 88 in the plastic sheets. The sheets are approximately 1-2 mm in thickness and can be made of polyethylene, polyvinyl chloride or any other suitable material that can be thermoformed to shape. Air channels 26 are formed on the ridges 29 and ridges 29 have air holes 88 formed in the tops thereby supplying pulsating water jets at specific zones.

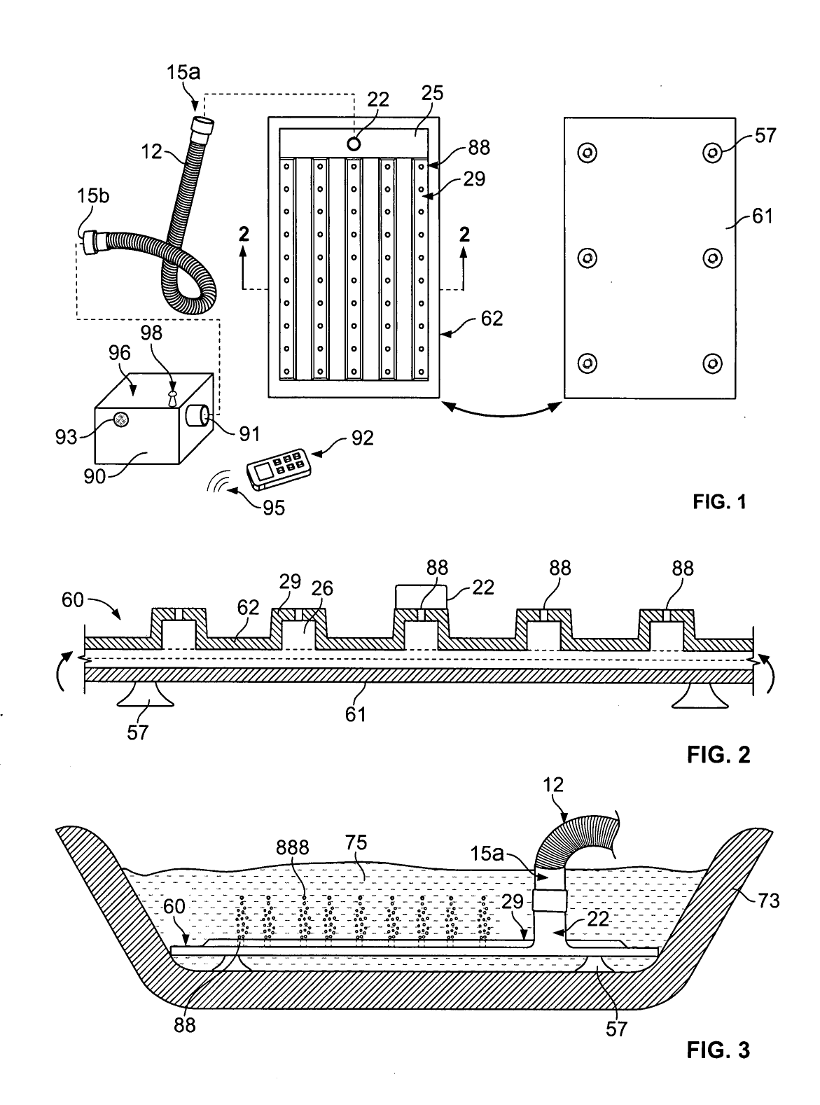

The hose connection 22 directs heated air into the bridge 25 portion of the board 60. The bridge 25 is an air channel that bridges all of the individual ridges 29. The bridge 25 provides air to the channels 26 of the ridges 29. In FIG. 1, the individual ridges 29 are formed as a series of parallel thermoformed longitudinal raised strips joined at an end by a bridge channel formed perpendicular to the individual ridges. The hose connection 22 is preferably placed in the middle of the raised bridge portion.

Although the board can also be thermally bonded together in between the ridges, it is not necessary as long as the peripheral edge of the board is thermally bonded together so that the bottom plate 61 and the top plate 62 both have a fused together periphery not allowing air to escape at the bonded periphery. The periphery would be defined as the edge of a rectangular shape, assuming that the board 60 is rectangular in the preferred embodiment. As seen in FIG. 1, the board 60 has a border where the thermal bonding takes place. A wide variety of manufacturing methods can create this thermal bonding along the rectangular periphery. The top plate and bottom plate can be bonded by a sonic welder or by heat. Also, the top and bottom plate can both be made of ABS plastic and laminated using cement.

During the thermal formation of the top plate, the ridges 29 are formed by pressing against a mold, the hose connection 22 is also drawn upward from the top plate sheet of plastic. The ridges 29 have a shallow profile so that the ridges 29 can support the weight of a user. The hose connection 22 preferably has a diameter suitable for connection with hose connector 15a. The preferred method is to draw the hose connection 22 upward as a bump and then make a cut to open the hose connection 22 and allow air flow to pass through the hose connection 22 when the hose connection 22 is connected to the hose connector 15a.

The bottom plate 61 and the top plate 62 both preferably have leathery surface texture embossed onto the plastic plate also called plastic sheet for a more comfortable tactile feel.

The flexible air hose 12 is connected to a water jet board 60. The flexible air hose has a first 15a and second connector 15b, one at each end. The hose connector 15a preferably has a snug fit to the hose connection 22 of the board 60 and the air outlet 91 of the air pump power unit 90. The hose connection 15a, 15b is snugly fit to a flexible hose 12. Flexible hose is commonly known in the industry, and can be corrugated or smooth. The flexible hose can be made of plastic or elastomeric material in a shape commonly found on vacuum cleaners or building ducts.

The jet is powered by the air pump instead of a water pump. When the jet forces air through air hole 88, water trapped within the airflow and is also pushed upward. The air holes 88 can be made by drilling, thermal formation, or by any other commonly known method. The bottom plate is preferably flat and preferably having a 0.06″ thickness whereas the top plate as a 0.09″ thickness. The thickness can be up to 0.125″ for either the top or the bottom plate. The bottom plate or the top plate can be thicker than the other or the same thickness. The bottom plate preferably has a plurality of suction cups 57 attached to the bottom of the bottom plate. The suction cups adhere to the tub 73 to stabilize the board inside the water 75 so that the bubble jets 888 can massage the user.

Compressed air is optionally heated by an electric resistance heater before it is introduced into the bathtub via the air hose. The power unit 90 can be pulsed in alternating step to provide a series of pulses to the user. The hydro-jet board serves as a transducer converting the compressed air into pulsating water jets in the bathtub. The air compression can be controlled by an air valve that opens and closes rapidly to provide rapid pulses of air blasts. Also, the air compression can be controlled by intermittently powering up the power unit 90.

The pulsating water jets vector vertically upward action offers anti-gravity benefits that helps relaxing muscles and joints lacking in traditional horizontal whirlpools. Also, while the user lies down flat against the hydro-jet board, which is affixed to the bottom of the bathtub, the entire back area is covered with numerous jets targeting at major acupressure points as well as joints. The user can also move the body around to treat other body components. Hands, knees, elbows, and feet, for example, can be treated accordingly.

The remote control 90 has a variety of settings that allows the user to adjust the thrust and temperature of the hydro-jet without leaving the bathtub. The remote control preferably also includes a variety of modes so as to give a user a variety of different jet bubble patterns. More than one device can also be used at the same time to provide multiple zones independently controlled and therefore providing an even greater variety of jet bubble patterns. The remote control preferably has a transmitter 95 that sends a signal to receiver 98 on the power unit 90. The signal can be infrared, or radio. The remote control typically has battery power and a pushbutton operation. Preferably, the remote control is waterproof in case the user drops the remote control 92 in the tub.

In typical operation, the user places the board 60 in the tub in a face up configuration so that the bubble jets 888 of water and air come from the air holes 88 to hit the user. The board 60 is preferably almost flat or slightly curved so that it matches the profile of the bottom of the tub 73. The air hose 12 is attached to the hose connection 22. Then, a user plugs in the power unit 90 and grabs the remote control 92. The user fills up the tub 73 with water 75 and proceeds to receive a bubble jet treatment. After the bubble jet treatment, the user drains the tub, takes out the board and detaches the board from the air hose. After drying off the board and air hose, the user can put all of the parts into a dedicated carry bag for storage or travel.

The present invention contemplates that other many changes and modifications may be made. For example, the suction cup 57 can be replaced by a grippy or adhesive bottom such as a rubbery elastomeric layer of material that is bonded to the bottom of bottom plate 61. Therefore, while the presently preferred form of the apparatus have been shown and described, and several modifications discussed, persons skilled in this art will readily appreciate that various additional changes and modifications may be made without departing from the spirit of the invention, as defined and differentiated by the following claims.

1. A spa tub apparatus comprising:
a. a power unit, pressurizing air in an air chamber, further including an air compressor mounted in the power unit, wherein the power unit further comprises an air heater which is an electrical motor pressurizing the air in the air chamber;
b. a flexible air hose, connected to the air chamber at a hose connector, receiving pressurized air from the air chamber;
c. a hydro-jet board, receiving pressurized air from the flexible air hose, wherein the hydro-jet board is formed of a top plastic thermoformed plate bonded at a periphery to a bottom plastic plate;
d. air channels formed between the bottom plastic plate and the top plastic thermoformed plate;
e. air holes located on the air channels;
f. suction cups mounted to the bottom plastic plate; and
g. a remote control controlling the power unit.

2. A spa tub apparatus of claim 1, wherein the air channels are formed as a series of parallel thermoformed raised strips of ridges.

3. A spa tub apparatus of claim 1, wherein the air channels are formed as a series of parallel thermoformed raised strips of ridges joined by a bridge.

4. A spa tub apparatus of claim 3, wherein the hose connection of the hydro-jet board is located in the middle of the bridge.

5. A spa tub apparatus of claim 3, wherein the hydro-jet board is formed of the top plastic thermoformed plate thermally laminated at the periphery to the bottom plastic plate;

6. A spa tub apparatus of claim 3, wherein the hose connection of the hydro-jet board is made by thermoforming and drawing the top plastic thermoformed plate to create the hose connection.

7. A spa tub apparatus of claim 3, wherein the bridge is perpendicular to the air channels.

8. A spa tub apparatus comprising:
a. a power unit, pressurizing air in an air chamber, further including an air compressor mounted in the power unit, wherein the power unit further comprises an air resistance heater and an electrical motor pressurizing the air in the air chamber;
b. a flexible air hose, connected to the air chamber at a hose connector, receiving pressurized air from the air chamber;
c. a hydro-jet board, receiving pressurized air from the flexible air hose, wherein the hydro-jet board is formed of a top plastic thermoformed plate bonded at a periphery to a bottom plastic plate;
d. air channels formed between the bottom plastic plate and the top plastic thermoformed plate;
e. air holes located on the air channels; and
f. a remote control controlling the power unit, wherein the remote control can turn on the power unit, turn off the power unit, and change the temperature of the air exiting an air outlet of the power unit.

9. A spa tub apparatus of claim 8, wherein the air channels are formed as a series of parallel thermoformed raised strips of ridges.

10. A spa tub apparatus of claim 8, wherein the air channels are formed as a series of parallel thermoformed raised strips of ridges joined by a bridge.

11. A spa tub apparatus of claim 10, wherein the hose connection of the hydro-jet board is located in the middle of the bridge.

12. A spa tub apparatus of claim 12, wherein the hydro-jet board is formed of the top plastic thermoformed plate thermally laminated at the periphery to the bottom plastic plate;

13. A spa tub apparatus of claim 12, wherein the hose connection of the hydro-jet board is made by thermoforming and drawing the top plastic thermoformed plate to create the hose connection.

14. A spa tub apparatus of claim 12, wherein the bridge is perpendicular to the air channels.

15. A spa tub apparatus comprising:
a. a power unit, pressurizing air in an air chamber, further including an air compressor mounted in the power unit, wherein the power unit further comprises an air resistance heater and an electrical motor pressurizing the air in the air chamber;
b. a flexible air hose, connected to the air chamber at a hose connector, receiving pressurized air from the air chamber;
c. a hydro-jet board, receiving pressurized air from the flexible air hose, wherein the hydro-jet board is formed of a top plastic thermoformed plate bonded at a periphery to a bottom plastic plate;
d. air channels formed between the bottom plastic plate and the top plastic thermoformed plate;
e. air holes located on the air channels;
f. a remote control controlling the power unit, wherein the remote control can turn on the power unit, turn off the power unit, and change the temperature of the air exiting an air outlet of the power unit; and
wherein the air channels are formed as a series of parallel thermoformed raised strips of ridges joined by a bridge, wherein the hose connection of the hydro-jet board is located in the middle of the bridge, wherein the hydro-jet board is formed of the top plastic thermoformed plate thermally laminated at the periphery to the bottom plastic plate;

16. A spa tub apparatus of claim 15, wherein the hose connection of the hydro-jet board is made by thermoforming and drawing the top plastic thermoformed plate to create the hose connection.

17. A spa tub apparatus of claim 15, wherein the bridge is perpendicular to the air channels.

18. A spa tub apparatus of claim 15, wherein the bottom is adhesive.

19. A spa tub apparatus of claim 15, wherein the bottom is grippy.
